(19) United States
(12) Patent Application Publication
(10) Pub. No.: US 2008/0015020 A1
(43) Pub. Date: Jan. 17, 2008

(54) Matching Numerical Values

(76) Inventor: Richard Allan Spears, Swindon (GB)

Correspondence Address: Mrs Alison Spears;Rasprodz (UK) Limited, 96 Padstow Road, Churchward, Swindon, SN2 2EG, GB

(21) Appl. No.: 10/597,042

(22) PCT Filed: Jan. 12, 2005
(86) PCT No.: PCT/GB05/00055

§ 371 Date: Jun. 26, 2007

(30) Foreign Application Priority Data
Jan. 12, 2004 (GB) 0400559.1

(51) Int. Cl. A63F 3/08; H04M 11/00

(52) U.S. Cl. 463/41; 379/93.13

(57) ABSTRACT

A method is disclosed of generating a broadcast from a broadcasting station (BS) in response to an input from a telephone (T1 to T5) to a computer (C) associated with the station, wherein: a numerical code is stored in the computer; a telephone link (TL1 to TL5) is established between the telephone and the computer; an operator of the telephone causes a signal comprising DTMF tones to be transmitted along the telephone link to the computer by selectively activating keys of a keypad of the telephone; upon receipt of the DTMF tone signal, the computer transcribes the tones into their associated sequential numerical values and compares those values with the stored numerical code; and wherein: the computer sends a signal to the broadcasting station to broadcast a result of the comparison made.

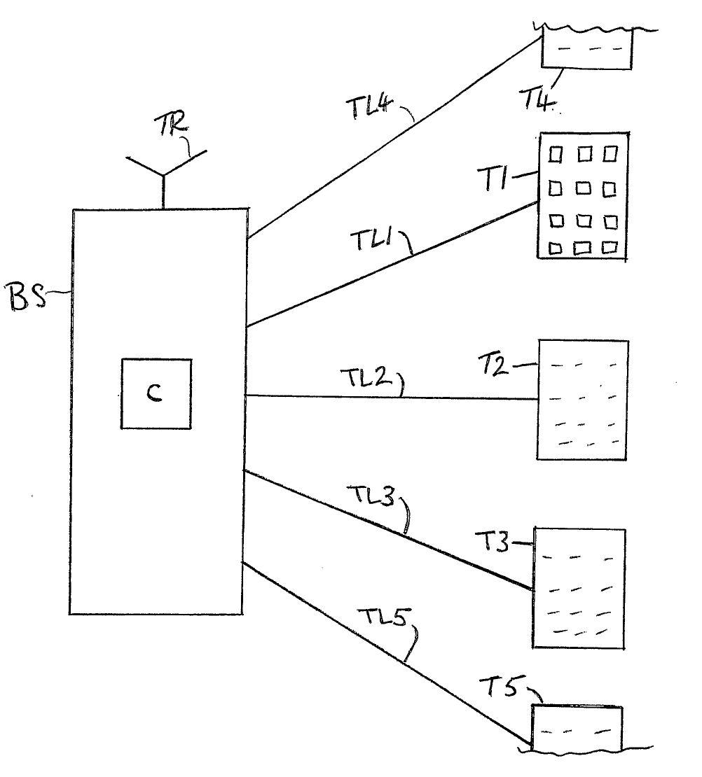

The present invention relates to the matching of numerical values, and finds application, by way of example only, in a game.

Games are known, for example, in which contestants attempt to identify a secret number by submitting numbers to a game controller and receiving back information on the relation, or lack of relation, between the submitted number and the secret number.

It is one object of the present invention to provide a method of, and system for, matching numerical values, for example in the context of a game, that minimises or even eliminates the use of a human controller.

The present invention involves the combination of a telephone line, using Dual Tone Multi Frequency (DTMF) tone signals generated by operation of the keypad of a telephone, to transmit a sequence to a computer, which then converts the DTMF signal back to a numerical sequence and compares that with a stored numerical code. The computer is linked with a media broadcasting station, such that a result of the comparison made, for example the transcribed incoming DTMF signal, together with any correlation with the stored code, may be broadcast to a wide audience, advantageously in real time.

Although the result of the comparison that is made by the computer may be the direct result of comparing the DTMF signal with the stored numerical code, it is also envisaged that the result that is broadcast may be derived from the comparison that is made. For example, the resulting broadcast may comprise further instructions to the operator of a telephone, which may require a further response to be made by operation of the telephone keypad with the consequential sending of further DTMF tone signals.

In one embodiment of the present invention, there is provided a method of generating a broadcast from a broadcasting station in response to an input from a telephone to a computer associated with the station, wherein: a numerical code is stored in the computer; a telephone link is established between the telephone and the computer; an operator of the telephone causes a signal comprising DTMF tones to be transmitted along the telephone link to the computer by selectively activating keys of a keypad of the telephone; upon receipt of the DTMF tone signal, the computer transcribes the tones into their associated sequential numerical values and compares those values with the stored numerical code; and wherein: the computer sends a signal to the broadcasting station to broadcast a result of the comparison made.

In another embodiment of the present invention, there is provided a method of identifying a numerical code stored in a computer, wherein a telephone link is established between a remote telephone and the computer, wherein an operator of the telephone causes a signal comprising DTMF tones to be transmitted along the telephone link to the computer by selectively activating keys of a keypad of the telephone, wherein upon receipt of the DTMF tone signal, the computer transcribes the tones into their associated sequential numerical values and compares those values with the stored numerical code, and wherein the computer is associated with a broadcasting medium and is arranged to produce a broadcast of a result of the comparison made.

The present invention thus allows members of an audience (players) to have complete control over a software driven game or application via any modern phone capable of generating DTMF signals.

While the games and broadcast applications may vary in concept and execution, they share a similar method of functionality dependant upon DTMF commands delivered via telephone lines in remote locations away from the broadcast stations, which are broadcast in real time either live or delayed.

Each game or application can be controlled only by one or more players on the other end of the phone by pressing the required numbers, the * (star), or # (hash) keys on their phone. The software is connected via a computer soundcard or modem to an analogue or digital telephone hybrid. The DTMF signal is sent to the hybrid then to the audio input of the computer's soundcard. The software interface is activated by a presenter of the game, which enables the software to detect the incoming DTMF signal.

Any audible instructions played by the software can be heard by the player through their telephone. This audio is also broadcast live and in real time.

The player presses the required keypad buttons on his telephone as instructed by audio prompts played by the software or as instructed by the presenter. Pressing these buttons generates the required DTMF to operate the software.

The generated DTMF and the software's response to the generated tones are also heard by the player through his telephone and broadcast live and in real time, preferably, or otherwise as a delayed broadcast.

Each step taken by any player controlling a game or application produces an audio and/or visual response which may be broadcast live and in real time, or as a delayed broadcast, as is the result of each game or application.

In said another embodiment of the invention, the computer may indicate what correlation, if any, exists between the transcribed numerical values and the stored code, even if the correlation is incomplete.

The computer is associated with a broadcasting medium, such as radio or television, and the computer preferably arranges a broadcast of the transcribed numerical values, and advantageously also any correlation with the stored numerical code.

Consequently, if the transcribed numerical values do not exactly match the stored code, an operator of another telephone, using another telephone link, may send a different DTMF tone signal to the computer in an attempt to match the numerical code stored in the computer.

Further operators may interactively submit DTMF tone signals along respective telephone links to the computer following broadcast details of a previous mismatch, until the computer detects, and preferably broadcasts, an exact match with the stored code.

In this way, the matching attempts of successive operators of telephones, emitting DTMF tones along telephone links, may be broadcast to a wide audience after each attempt, by means of the operation of the computer.

The code that is initially stored within the computer is advantageously generated at random, and is not identified until the computer detects an exact match therewith. In this way, any human interference with the matching can be avoided.

The code may comprise four numbers, or more or fewer numbers. The numbers may represent other parameters, such as letters (e.g. as used in mobile telephone text messaging), symbols, colours or sounds, for example.

Preferably, the specification of the computer, and for example the speed of its processor, is such that the DTMF tones received along the telephone link are detectable and transcribable using the built-in sound card of the computer, that is to say, without the need for a modem. An Intel Pentium 4 processor, for example, is suitable for such an application of the present invention.

It will be appreciated that the combination of a telephone link, using DTMF tones, with a computer associated with media broadcasting, that is envisaged in the present invention, involves the use of a telephone hybrid device, which may be analogue or digital, for separating the electric current signal that powers the telephone from the audio signal that comprises the DTMF tones, thus allowing the broadcasting of the audio signal.

It will be appreciated that broadcasting may involve a transmitter and a receiver aerial, or a cable or a satellite link.

In a further embodiment of the present invention, there is provided an electronic system for matching, or otherwise comparing, a signal comprising a sequence of DTMF tones representing numerical values received along a telephone line with a numerical code stored within the system, and broadcasting a result of the comparison made.

The system may comprise a computer having a sound card responsive to the DTMF tone signal so as to transcribe the tones into an associated sequence of numbers.

Advantageously, the computerised system is linked with, or forms part of a media (radio or television) broadcasting system, whereby the numerical sequence derived from the received DTMF tones may be broadcast, and whereby a correlation, or a lack of correlation, between the derived numerical sequence and the stored numerical code may be broadcast. The system may be used iteratively, for receiving successive DTMF tones from different sources, preferably telephone keypads, subsequent to each broadcast, until the stored CODE is identified.

In other embodiments of the invention, the comparison made by the computer may result in broadcasting of an audio and/or video signal, for example, the playing of a tune or the showing of a still or moving picture.

It is to be appreciated that, in accordance with the present invention, the system and arrangements of the invention may be arranged to carry out the method steps thereof.

Embodiments of the present invention will now be described, by way of example, with reference to the accompanying schematic system diagram, in the context of games.

Referring to the drawing, a broadcasting station BS is arranged to broadcast to an audience via a transmitter TR, for reception on a radio receiver (not shown) in the normal manner. The broadcasting station BS is arranged to broadcast a game in which its listeners participate, and respond thereto interactively by means of their remote telephone keypads T1, T2, T3, T4 and T5, for example, which are linked to the broadcast station BS by telephone lines TL1, TL2, TL3, TL4, TL5 respectively. Each telephone keypad T1-T5 is equipped with the usual ten numerical touch tone buttons 0, 1, . . . 8, 9.

At the broadcasting station BS, a computer C is arranged to randomly generate and store a four digit number as a CODE to be identified by the participants in the game. The game host will broadcast over the transmitter TR the fact that a CODE has been generated, and invite participants to submit entries so as to identify the CODE, and consequently to win a prize. A participant, for example associated with the telephone keypad T1, can then telephone the broadcasting station BS, and establish a standard telephone link along the line TL1 therewith. When invited by the game host, the operator of the keypad T1 enters the four digits that he guesses correspond to the stored CODE. Entry is effected by pressing appropriate ones of the keys 0 . . . 9 of the keypad T1, and this generates a sequence of four DTMF tones that are transmitted along the telephone line TL1 to the computer C at the broadcasting station BS.

The computer C, using its sound card associated with its Intel Pentium 4 processor, converts the sequence of four DTMF tones back into the corresponding numbers, and automatically arranges for the numbers, in the sequence received, to be broadcast by the transmitted TR to the audience of the broadcasting station BS. Additionally, the computer C compares the sequence of numbers received with the stored CODE and then also arranges to broadcast from the transmitter TR any correlation between the received digits and the CODE. For example, if the randomly generated and stored CODE were 1234 and the entry made via the keypad terminal T1 were converted from its DTMF tones to the numerical sequence 1574, the computer would recognise that the first and fourth digits were correct, in the sense that they provide a numerical match and also appear at the same position in the sequence, and that the second and third digits did not match. The computer is then arranged to broadcast via the transmitter TR the fact that two of the four digits received from the terminal T1 and broadcasted provided a match with the stored CODE, but without identifying the value or position in the sequence of those two digits. Other members of the audience may then in turn, by establishing links from their respective keypad terminals T2 . . . T5 along the respective telephone lines TL2 . . . TL5 subsequently enter their own attempts on their own keypads in order to identify the stored CODE. It will be appreciated, that successive attempts will be made in the knowledge of the broadcasting of any matching of digits by previous attempts with the stored CODE. The process carries on iteratively, until a participant correctly identifies the CODE, that is to say keys into his keypad TX the correct four digits in the correct order corresponding to the stored CODE. At this point, the game ends and a prize is awarded. A further game can then be instigated, by having the computer C generate at random a new CODE.

In the embodiment described, use of only the keys 0, . . . 9 of the telephone keypad has been described. However, it is envisaged that the * and/or # keys may also be activated during the communication with the computer C of the broadcasting station BS. For example, depression of the * key may be required to activate the tone detection process of the computer software, so that the participant may then be allowed to play the game. These keys may be used for effecting commands, choices or navigation of the software or the game by the participant.

It will be appreciated that the system described above contains other, standard, components that are not shown in the schematic diagram, but which will be apparent to one skilled in the art. Examples of such components are a telephone hybrid device, a telephone interface, and a broadcast console/mixer, which are required to enable the DTMF signals to be sent as a usable audio signal to the sound card of the computer, triggering various audio files which the software replays through the audio output stage of the sound card and back to the input channel of the broadcast console/mixer so that all audio can be broadcast. Additionally, it will be understood that the sound card, which is not shown, also acts as the output stage which plays the audio files as a result of the tones detected, and which are also broadcast.

Although reference is made in the above embodiment to identifying a numerical code, it will be appreciated that the number generated by the computer may represent other parameters, and that the corresponding numbers or symbols on the telephone keypads would then have the same correspondence with those parameters.

Further examples of applications of the present invention will now be described.

Another application of the present invention is in a game based on a traditional slot/fruit gaming machine as played in casinos or amusement arcades.

The method of this game for broadcast requires one player at a remote location using a modern telephone, capable of generating DTMF signals which is connected to the broadcast studio telephone hybrid which is connected to the soundcard of the computer controlled by the game software.

The software contains a number of pre recorded celebrity names or personal ID's (eg “Hi this is Kylie Minogue”) as audio wav files which is broadcast and accompanied by visual images of the celebrity that is displayed on the software interface.

This game replicates a slot/fruit machine using 3× virtual reels each containing any number of images, in this case images of celebrities. Each image is linked to the relevant audio file.

The object of the game is to have all 3 reels stop on the same image to win the prize.

Different matching images may be varying in value, for example:

3× Celebrity A=$1000

3× Celebrity B=$800

3× Celebrity B=$600

3× Celebrity C=$400

3× Celebrity D=$100

As an option, players who stop 2 out of 3 matched celebrities may be given a second attempt at matching 3 celebrities.

The game interface is activated by the presenter, which puts the software into “listening mode”.

The interface enables the software to detect DTMF signals and play series of audio files and/or display graphics as determined by the player's choices of actions. For example, the player presses the # (hash) key on his telephone. This pulls the virtual ‘handle’ and spins all 3 reels. The software plays a sound effect audio file indicating that the wheels are spinning. The interface displays all 3 reels spinning each containing images of the celebrities.

The reels may be stopped in any order and at any time by the player.

The game may be played as follows:

A presenter activates the interface.

A player presses # (hash) key on his telephone keypad. The 3 reels spin in unison.

The player presses ‘3’ on his telephone keypad. This is detected by the software and immediately stops the third reel. The software then plays an audio file indicating that reel 3 has been stopped, followed by the audio file of the celebrity which has been stopped, e.g. Celebrity D.

Reels 1 and 2 continue to spin.

The player then presses ‘2’ on his telephone keypad. This is detected by the software and immediately stops the second reel. The software then plays an audio file indicating that reel 2 has been stopped, followed by the audio file of the celebrity which has been stopped, e.g. Celebrity A.

Reel 1 continues to spin.

The player then presses ‘1’ on his telephone keypad. This is detected by the software and immediately stops the first that reel. The software then plays and an audio file indicating that reel 1 has been stopped, followed by the audio file of the celebrity which has been stopped, e.g. Celebrity A.

All 3 reels have now been stopped.

The outcome of the game is that 2 out of 3 celebrities have been matched and the player may be offered another attempt. If not, the player has lost this game.

A game is only won when 3 of the same celebrities have been stopped.

Another application of the present invention is suited to radio stations that choose to allow their audience to select music from a predetermined list of songs to be broadcast.

This type of application is designed for stations wishing to present “listener controlled” type of specialized programming. Unlike more traditional ‘request’ type of programming, this application gives listeners total, real time control over the choice made.

Traditional ‘request’ type programs consist of a listener calling the presenter and verbally asking for a song to be played by saying the song title and artist. In most cases these calls are prerecorded and replayed at a later time as the presenter may not have instant access to the song requested and ready to be played. In other cases, a listener is asked off air what song they would like to request so the presenter has time to make the necessary preparations, or the caller is told by the presenter which song they are to request when the caller is put live to air.

This application instantly plays an audio file (pre loaded song) identified by a number, comprising three or four digits, or another number of digits, which is chosen by entering the number the keypad of a modern telephone capable of generating DTMF signals.

A pre selected library of songs may be posted on a website or published in printed form so listeners can note the number given to each song.

This broadcasting arrangement may operate as follows:

A listener calling the station has been invited to select any song of their choice from the posted list.

Song A=0045

Song B=0046

Song C=0047

Etc.

The presenter activates the interface enabling the software to detect incoming DTMF signals, then instructs the caller to enter the number of their chosen song on his telephone keypad. The caller enters 0046 on his telephone keypad. The software, by comparison with the stored numbers, detects the tones 0046 which is assigned to Song B as chosen by the caller. The software may then play audio sound effects to simulate the mechanics of a real jukebox, followed by the song selected by the caller, as a broadcast.

Yet another application of the present invention is based on the traditional type of contestant “buzzer” used in television games shows.

The method of this application for broadcast requires two or more players at remote locations each using a modern telephone capable of generating DTMF signals on separate telephone lines connected to the broadcast studio telephone hybrid which is connected to the soundcard of the computer controlled by the game software. The software contains a number of pre recorded audio files that are made audible when the software detects DTMF signals from the players. These audio files are broadcast to indicate which of the two or more players pressed their assigned telephone keypad number first.

This application is best suited to virtually any ‘question and answer’ type game that is broadcast on radio and television where the contestants are not physically in the broadcast studio with the presenter.

Each player is assigned a number on his telephone keypad to simulate his “buzzer” which he must press before the other competitors in an attempt to be chosen to answer a question.

The software determines which player pressed their assigned keypad number first, by comparison.

This application may operate as follows:

Player A is assigned keypad #1

Player B is assigned keypad #2

Player C is assigned keypad #3

Player D is assigned keypad #4

When all players are ready to answer questions given by the presenter, the interface is activated and is ready to detect incoming DTMF signals.

The presenter asks the first question. All players press their assigned keypad, which sends four different tones (DTMF) to the software of the computer. The software comparatively determines which player pressed his assigned keypad first and gives the result by playing an audio file stating which of the four players was first, and also displays this result on the interface for the presenter to see.

This process continues until the game is deemed won by one of the players.

A further application of the present invention is in a game based on the traditional card game called ‘Snap’

The method of this game for broadcast requires two, or more, players at remote locations each on a separate DTMF telephone line connected to the broadcast studio telephone hybrid which is connected to the soundcard of the computer controlled by the game software.

The software may contain a number of pre recorded audio or visual files, for example celebrity names or personal IDs (eg “Hi this is Kylie Minogue”) as an audio wav file which is broadcast and accompanied by a visual image of the celebrity that is displayed on the software interface. When the game is activated by the presenter, the software plays these audio and graphics files at random one after another. Points are accumulated as each celebrity audio file is played. When the same celebrity audio file and/or graphic is played/displayed more than once in a row, the players must attempt to press the assigned key on their telephone keypad to simulate a ‘snap’. The software determines which player has pressed their assigned key first and awards the player with the total amount of points accumulated from that round. The points are reset to zero before continuing with the next round.

If either player presses his assigned key when there has been no similar audio files and/or display graphics played in succession, the opposing player is awarded the accumulated points from that round. The points are then reset before the next round is commenced.

The winner of the game after a predetermined number of maximum rounds is the player that has accumulated the most number of points.

This game may be played as follows:

Round 1

Player A is assigned the * (star) key on his telephone keypad

Player B is assigned the # (hash) key on his telephone keypad

The presenter starts the game interface. The interface enables the software to detect DTMF signals and to play at random a series of audio files and/or display graphics one after another, e.g.

Celebrity A

Celebrity D

Celebrity E

Celebrity C

Celebrity A

Celebrity F

Celebrity F

Both players A and B press their assigned keys to ‘snap’ the last matching pair. Both players' telephones emit a DTMF signal (both * and #) which are detected by the software. The round is instantly halted. The software comparatively detects that player A pressed his assigned key first, and the software indicates that Player A is the winner of the round.

The points accumulated from this round are awarded to player A automatically by the software

Round 2

The presenter activates the next round on the interface. The points are reset. The interface again plays at random a series of audio files and/or display graphics one after another, e.g.

Celebrity D

Celebrity E

Celebrity B

Celebrity C

Celebrity F

Celebrity G

Celebrity A

Celebrity G

Celebrity B

Player B presses his assigned key to ‘snap’ the last celebrity pair. Player B's telephone emits a DTMF signal (#), which is detected by the software. The round is instantly halted. The software comparatively determines and indicates that the last two audio/graphic files were not a similar or matching pair, and automatically awards the point accumulated from the previous round to Player A.

Round 3

The presenter activates the next round on the interface. The points are reset. The interface again plays at random a series of audio files and/or display graphics one after another, e.g.

Celebrity B

Celebrity E

Celebrity A

Celebrity G

Celebrity E

Celebrity A

Celebrity C

Celebrity C

Both players A and B press their assigned keys to ‘snap’ the last matching pair. Both players' telephones emit DTMF signals (both * and #) which are detected by the software. The round is instantly halted. The software comparatively detects that player B pressed his assigned key first. The software indicates that Player B is the winner of the round, and the points accumulated from this round are awarded to player B automatically by the software.

The game ends after a predetermined number, for example three, of rounds have been played.

The software determines that player A has accumulated the most points and announces in a broadcast that player A is the overall winner of the game.

It will thus be appreciated that the present invention may find application in operating a game, or other functions, that can be played interactively and broadcast live and in real time or as a delayed broadcast.

It is to be understood that the rules and/or objects of a game may differ from those of the specific examples described herein, whilst incorporating the underlying technical features of the present invention.

1. A method of generating a broadcast from a broadcasting station in response to an input from a telephone to a computer associated with the station, wherein:
a numerical code is stored in the computer;
a telephone link is established between the telephone and the computer;
an operator of the telephone causes a signal comprising DTMF tones to be transmitted along the telephone link to the computer by selectively activating keys of a keypad of the telephone;
upon receipt of the DTMF tone signal, the computer transcribes the tones into their associated sequential numerical values and compares those values with the stored numerical code;
and wherein:
the computer sends a signal to the broadcasting station to broadcast a result of the comparison made.

2. A method according to claim 1, wherein the broadcast takes place in real time.

3. A method according to claim 1 or claim 2, wherein the broadcast is of an audio and/or video signal.

4. A method according to any one of the preceding claims wherein the computer is arranged to receive successive DTMF signals, from the same telephone or from different telephones, prior to broadcasting the result.

5. A method of identifying a numerical code stored in a computer, wherein a telephone link is established between a remote telephone and the computer, wherein an operator of the telephone causes a signal comprising DTMF tones to be transmitted along the telephone link to the computer by selectively activating keys of a keypad of the telephone, wherein upon receipt of the DTMF tone signal, the computer transcribes the tones into their associated sequential numerical values and compares those values with the stored numerical code, and wherein the computer is associated with a broadcasting medium and is arranged to produce a broadcast of a result of the comparison made.

6. A method according to any one of the preceding claims, wherein the computer indicates what correlation, if any, exists between the transcribed numerical values and the stored code.

7. A method according to claim 6, wherein the computer indicates a correlation only of the numbers and not of their position in the sequence.

8. A method according to any one of the preceding claims, wherein the broadcast result comprises the transcribed numerical values.

9. A method according to claim 8, wherein the computer is arranged to broadcast any correlation with the stored numerical code.

10. A method according to any one of the preceding claims, wherein the computer is arranged to receive successive DTMF signals, preferably from different remote telephones, until a complete match with the stored numerical code is received in a single DTMF signal.

11. A method according to claim 6, wherein the computer is arranged to broadcast the matched numerical code.

12. A method according to any one of the preceding claims, wherein the code that is initially stored within the computer is generated at random.

13. A method according any one of the preceding claims, wherein the code comprises four numbers.

14. A method according to any one of the preceding claims, wherein the result of the comparison that is broadcast comprises instructions that require a response of DTMF signals.

15. An electronic system for comparing a signal comprising a sequence of DTMF tones representing numerical values received along a telephone line with a numerical code stored within the system, and broadcasting a result of the comparison made.

16. A system according to claim 15, comprising a computer having a sound card responsive to the DTMF tone signal so as to transcribe the tones into an associated sequence of numbers.

17. A system according to claim 15, comprising a modem for use in effecting the matching of the numerical values with the numerical code.

18. A system according to any one of claims 15 to 17 wherein a correlation, or a lack of correlation, between the derived numerical sequence and the stored numerical code is broadcast.

19. A system according to any one of claims 15 to 18, for receiving successive DTMF tones from different sources, preferably telephone keypads, subsequent to each broadcast, until the stored numerical code is identified.

20. A system according to any one of claims 15 to 19, wherein the computer is arranged to simulate operation of a slot/fruit gaming machine, by depicting and broadcasting images of rotating reels in response to the matched DTMF signals received from the telephone, and broadcasting the result of a predetermined combination thereof.

21. A system according to any one of claims 15 to 19, wherein the computer is arranged to simulate a jukebox, and to broadcast songs, and, optionally, associated video signals, in response to the matched DTMF signals received from the telephone.

22. A system according to any one of claims 15 to 19, wherein the computer is arranged to broadcast replies to questions, subsequent to selecting participants by comparison of responses submitted as the DTMF signals with stored values in the computer.

23. A system according to any one of claims 15 to 19, wherein DTMF signals from operators of two, or more, remote telephones are compared with a broadcast of successive stored values to detect a match therebetween.

24. A system according to any one of claims 15 to 23, wherein the specification of the computer is such that the DTMF tones received along the telephone link are detectable and transcribable using the sound card or modem of the computer.

25. An arrangement comprising a telephone arranged to generate DTMF tone signals by operation of keys of its keypad, a computer arranged to transcribe DTMF signals into an associated numeral sequence, a communications link for transmitting the DTMF signals from the telephone to the computer, and a broadcasting station, wherein the computer is arranged to generate and to store a randomly generated numerical code, and wherein the computer is arranged to compare the number entered into the telephone keypad, as transcribed, with the stored numerical code, and wherein the broadcasting station is arranged to broadcast the correlation, or lack of correlation, between the numerical sequence and the stored numerical code.
